(19) United States
(12) Patent Application Publication
(10) Pub. No.: US 2026/0259965 A1
(43) Pub. Date: Sep. 3, 2026

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Yoshinori Ando, Kanagawa (JP)

(73) Assignee: FUJIFILM Business Innovation Corp., Tokyo (JP)

(21) Appl. No.: 19/309,249

(22) Filed: Aug. 25, 2025

(30) Foreign Application Priority Data
Mar. 3, 2025 (JP) 2025-032864

(51) Int. Cl. G06F 21/31; G06F 21/46

(52) U.S. Cl. CPC G06F 21/31; G06F 21/46; G06F 2221/2117; G06F 2221/2131

(57) ABSTRACT

An information processing apparatus includes a processor configured to: receive input of multiple reset codes, corresponding to multiple information processing apparatuses, for resetting a previously set password; transmit the input reset codes and the information processing apparatus's own identification information to an external device; if there is a response from the external device indicating permission for password reset, set information entered as a new password; and transmit the input reset codes to other information processing apparatuses that have been pre-registered as belonging to a same group.

### CROSS-REFERENCE TO RELATED APPLICATIONS

This application is based on and claims priority under 35 USC 119 from Japanese Patent Application No. 2025-032864 filed Mar. 3, 2025.

### BACKGROUND

### i. Technical Field

The present disclosure relates to an information processing apparatus, a non-transitory computer readable medium, and an information processing method.

### ii. Related Art

Japanese Unexamined Patent Application Publication No. 2023-010029 discloses a server that, upon receiving a change instruction from a terminal to change a password of a communication device, transmits authentication information to the terminal and, upon receiving this authentication information from the communication device, transmits a change permission notification, which is a notification to permit the communication device to change the password, to the communication device.

### SUMMARY

An information processing apparatus such as an image forming apparatus may sometimes request a user to enter a password for authentication. For example, in an image forming apparatus commonly referred to as a multifunction device, a user responsible for managing the image forming apparatus may be set as a device administrator, and, in some cases, when performing operations, the device administrator may be required to log in by entering a password. In order to accommodate situations where the device administrator forgets the password for logging in as the device administrator, it is made so that the password can be reset. Specifically, a reset code for resetting the password is issued from the manufacturer of the image forming apparatus, and the reset code is input into the image forming apparatus, thereby resetting the password.

However, when a single device administrator manages multiple image forming apparatuses, it is common that the device administrator sets the same password, and, if the device administrator forgets the password, it becomes necessary to reset the password on each of the multiple image forming devices. When these image forming apparatuses are installed far apart or on different floors, resetting the password on each of them requires a great deal of time and effort.

Aspects of non-limiting embodiments of the present disclosure relate to providing an information processing apparatus, a non-transitory computer readable medium, and an information processing method capable of executing a password reset on multiple image forming apparatuses by performing an operation on only one image forming apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to: receive input of multiple reset codes, corresponding to multiple information processing apparatuses, for resetting a previously set password; transmit the input reset codes and the information processing apparatus's own identification information to an external device; if there is a response from the external device indicating permission for password reset, set information entered as a new password; and transmit the input reset codes to other information processing apparatuses that have been pre-registered as belonging to a same group.

### BRIEF DESCRIPTION OF THE DRAWINGS

An exemplary embodiment of the present disclosure will be described in detail based on the following figures, wherein:

FIG. 1 is a diagram illustrating a system configuration of an information processing system according to an exemplary embodiment of the present disclosure;

FIG. 2 is a block diagram illustrating a hardware configuration of an image forming apparatus in the exemplary embodiment of the present disclosure;

FIG. 3 is a block diagram illustrating a functional configuration of the image forming apparatus in the exemplary embodiment of the present disclosure;

FIG. 4 is a diagram for describing the situation in which a password reset is executed on a first image forming apparatus;

FIG. 5 is a diagram illustrating an example of a reset code management table stored in a management server;

FIG. 6 is a diagram illustrating an example of an operation screen when inputting reset codes for three devices on the first image forming apparatus;

FIG. 7 is a diagram illustrating the situation in which the reset codes for the three devices, input on the first image forming apparatus, are managed and stored using a table;

FIG. 8 is a diagram illustrating an example of an operation screen when requesting a device administrator to enter information to be set as a new password;

FIG. 9 is a diagram illustrating the flow of processing when a password reset is performed on second and third image forming apparatuses after the password reset has been performed on the first image forming apparatus; and

FIG. 10 is a diagram illustrating an example of a display screen of the processing result of the password reset displayed on an operation panel of the first image forming apparatus.

### DETAILED DESCRIPTION

An exemplary embodiment of the present disclosure will now be described in detail with reference to the drawings.

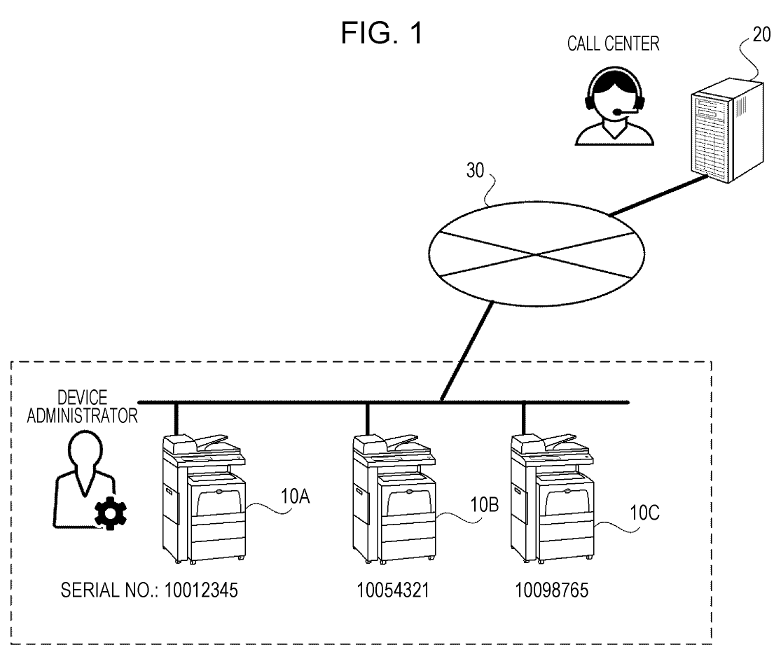

FIG. 1 is a diagram illustrating a system configuration of an information processing system according to the exemplary embodiment of the present disclosure.

The information processing system according to the exemplary embodiment of the present disclosure is configured, as illustrated in FIG. 1, with multiple image forming apparatuses 10A to 10C and a management server 20, which are connected by the Internet 30. Note that the image forming apparatuses 10A to 10C are devices commonly referred to as multifunction devices that have multiple functions, such as a print function, a scan function, a copy function, and a fax function.

The image forming apparatuses 10A to 10C are installed and used, for example, at various locations within a certain company. In this company, multiple users use the image forming apparatuses 10A to 10C. Note that the image forming apparatuses 10A to 10C have the same functions, and when not distinguishing between them, they are collectively referred to as the image forming apparatus(es) 10. Note that the serial number of the image forming apparatus 10A is "10012345". Additionally, the serial number of the image forming apparatus 10B is "10054321". Furthermore, the serial number of the image forming apparatus 10C is "10098765".

In addition, the management server 20 is a management apparatus for managing many image forming apparatuses 10, including the image forming apparatuses 10A to 10C. This management server 20 is installed, for example, at a call center established by the manufacturer of the image forming apparatuses 10.

Here, a user selected from among the users of the image forming apparatuses 10 may be designated as a device administrator to manage the image forming apparatuses 10. The device administrator, when using one of the image forming apparatuses 10, enters a password to be authenticated, thereby logging in as the device administrator. Then, the user who has logged in as the device administrator becomes able to perform various operations that are not permitted to general users other than the device administrator.

However, if the device administrator forgets this password, they become unable to log in as the device administrator. Therefore, in case the device administrator forgets the password, it is made so that the password can be reset. Specifically, the device administrator who has forgotten the password calls the call center representative to have a reset code issued for resetting the password. Then, by entering the issued reset code into the image forming apparatus 10, the device administrator becomes able to reset the password.

However, when one device administrator manages multiple image forming apparatuses 10, the same password is often set for the multiple image forming apparatuses 10. Therefore, if the device administrator forgets one password, it becomes necessary to perform password reset on multiple image forming apparatuses 10 at the same time. When these image forming apparatuses 10 are installed far apart or on different floors, resetting the password on each of them requires a great deal of time and effort.

Accordingly, in the present exemplary embodiment, by performing control as described below, it is made possible to execute a password reset on multiple image forming apparatuses 10 by performing an operation on only one image forming apparatus 10.

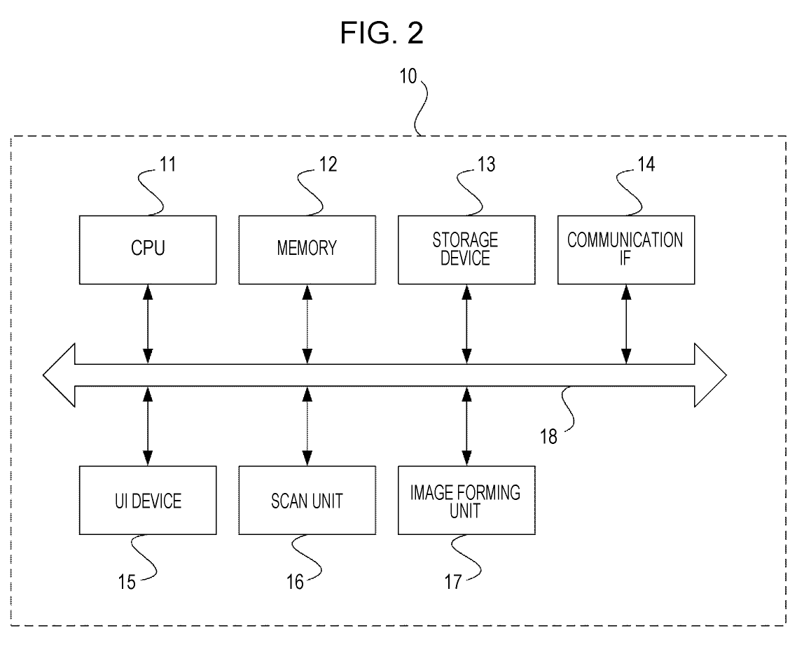

Next, FIG. 2 illustrates a hardware configuration of the image forming apparatus 10 according to the present exemplary embodiment.

The image forming apparatus 10 includes, as illustrated in FIG. 2, a central processing unit (CPU) 11, memory 12, a storage device 13 such as a hard disk drive (HDD), a communication interface (abbreviated as IF) 14 that transmits and receives data to and from external devices or the like via the Internet 30 or a network, a user interface (abbreviated as UI) device 15 including a touchscreen or a liquid crystal display as well as a keyboard, a scan unit 16, and an image forming unit 17. These components are connected to each other via a control bus 18.

The image forming unit 17 prints an image on a recording medium such as printing paper through steps such as charging, exposure, developing, transferring, and fixing.

The CPU 11 is a processor that executes a predetermined process based on a control program stored in the memory 12 or the storage device 13 to control the operation of the image forming apparatus 10. Note that, in the present exemplary embodiment, the CPU 11 has been described as reading and executing the control program stored in the memory 12 or the storage device 13, but it is not limited to this. The control program may also be provided in the form of being recorded on a computer-readable recording medium. For example, the control program may be provided in the form of being recorded on an optical disc such as a compact disc read-only memory (CD-ROM) or digital versatile disc (DVD)-ROM, or in the form of being recorded on a semiconductor memory such as a Universal Serial Bus (USB) memory or a memory card. The control program may also be obtained from an external device via a communication line connected to the communication interface 14. Furthermore, the control program may be provided as standalone application software, or the control program may be incorporated into the software of each device as a function of the image forming apparatus 10.

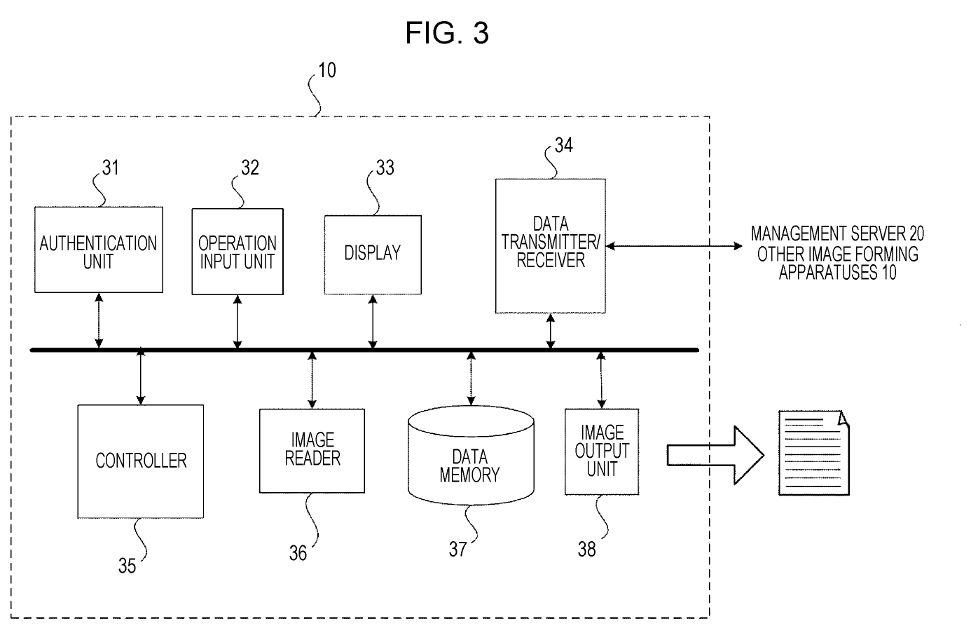

FIG. 3 is a block diagram illustrating a functional configuration of the image forming apparatus 10 realized by execution of the above-described control program.

The image forming apparatus 10 according to the present exemplary embodiment includes, as illustrated in FIG. 3, an authentication unit 31, an operation input unit 32, a display 33, a data transmitter/receiver 34, a controller 35, an image reader 36, a data memory 37, and an image output unit 38.

The data transmitter/receiver 34 transmits and receives data to and from the management server 20 and external devices such as other image forming apparatuses 10.

The controller 35 controls the operation of the image forming apparatus 10 and performs control such as outputting print data from the image output unit 38. The data memory 37 stores various data such as print data generated by the controller 35.

The display 33 is controlled by the controller 35 to display various types of information to the user. The operation input unit 32 inputs various types of operation information performed by the user.

The image output unit 38 outputs an image onto a recording medium such as printing paper, based on control by the controller 35. The image reader 36 reads a document image from a set document, based on control by the controller 35.

The authentication unit 31 authenticates a user who intends to use the image forming apparatus 10. In the present exemplary embodiment, the authentication unit 31 authenticates a user attempting to log in as a device administrator by using a password, and if the authentication is successful, permits the user to log in as a device administrator.

Next, the operation of the image forming apparatus 10 in the present exemplary embodiment when resetting a password will be described in detail with reference to the drawings.

In the following description, the device administrator is described as managing the three image forming apparatuses 10A to 10C illustrated in FIG. 1. Then, the device administrator is described as having set the same password on the three image forming apparatuses 10A to 10C, and having forgotten the password.

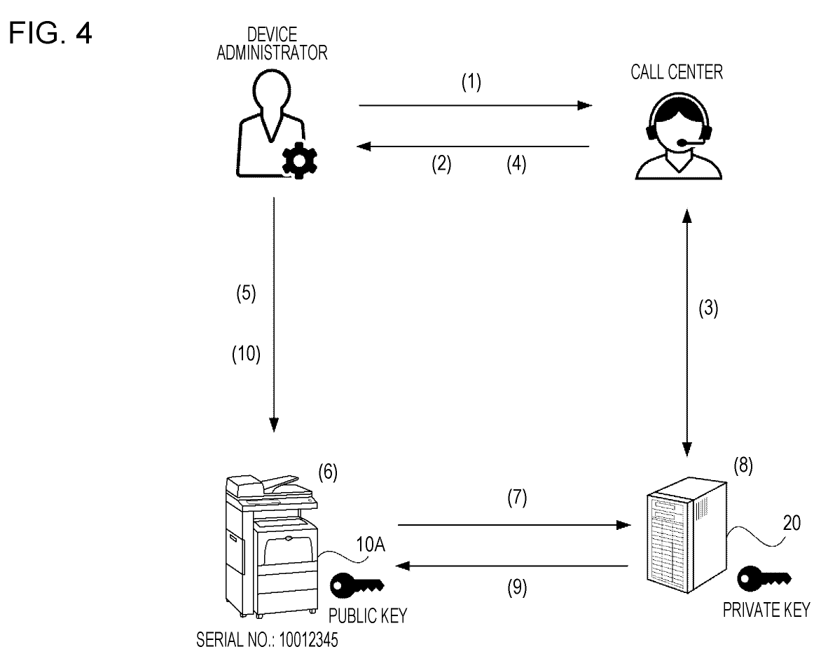

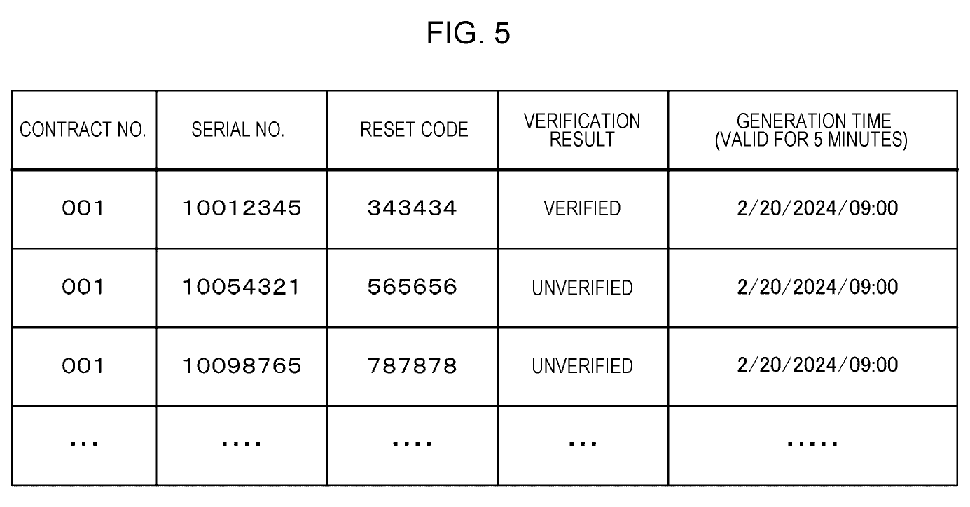

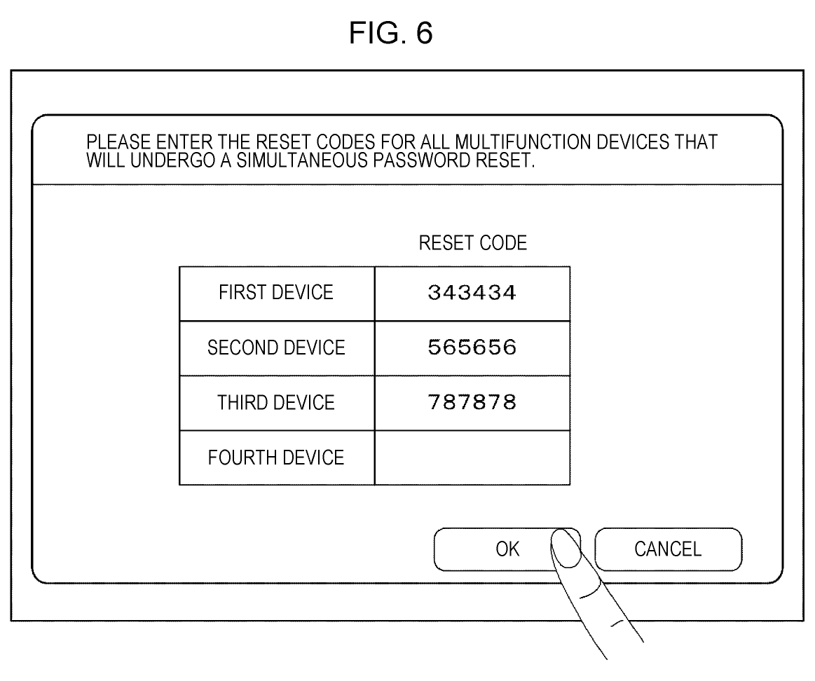

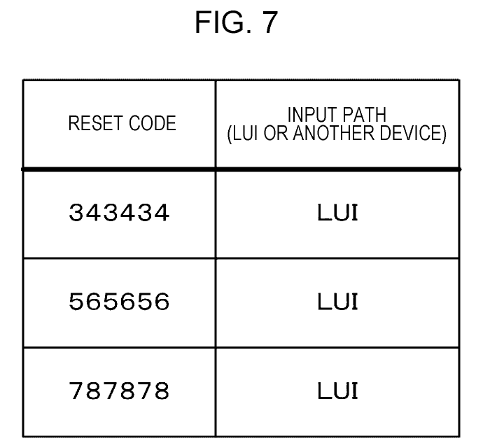

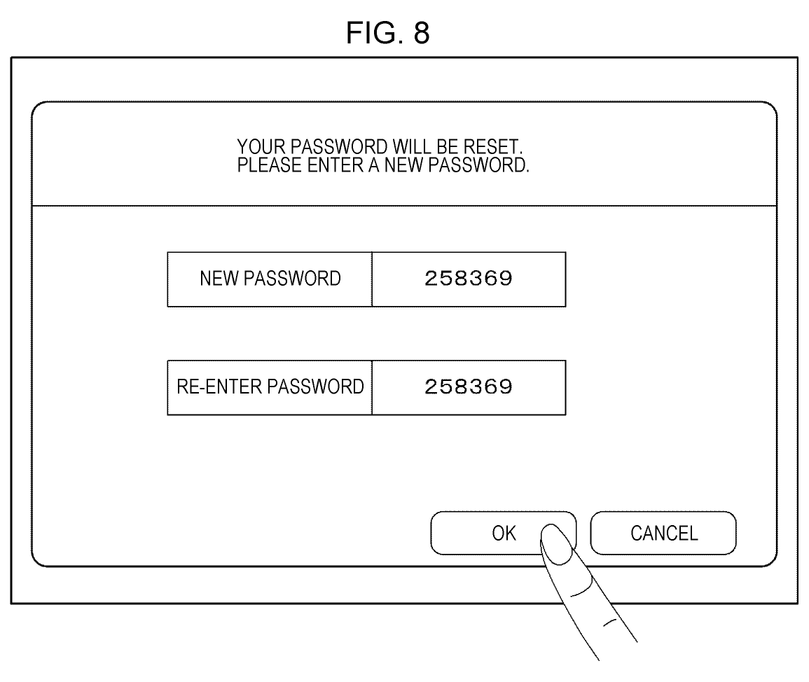

The flow of processing for the device administrator to reset the password is illustrated in FIG. 4. In FIG. 4, a password reset on the first device, the image forming apparatus 10A, is executed in accordance with steps (1) to (10) described below.
(1) The device administrator calls the call center and requests the representative to reset the password. At that time, the device administrator provides the call center representative with the serial numbers "10012345", "10054321", and "10098765" of the three image forming apparatuses 10A to 10C on which a password reset is to be performed.
(2) The call center representative verifies the identity of the caller by checking the contract number or using other methods.
(3) If the identity is verified, the call center representative inputs the serial numbers "10012345", "10054321", and "10098765" into the management server 20 to execute a reset code generation process. Here, reset codes are generated, for example, as random numbers of about six digits. Additionally, these reset codes are time-limited and become invalid after a certain validity period. Furthermore, one reset code is issued for each serial number. Examples of reset codes generated as above are indicated in FIG. 5. FIG. 5 is a diagram illustrating an example of a reset code management table stored in the management server 20. Referring to the reset code management table illustrated in FIG. 5, it can be seen that a reset code is issued for each serial number, with a validity period set along with the generation time.
(4) When the reset codes are issued in this manner, the call center representative communicates the issued reset codes to the device administrator by phone. Here, the call center representative conveys the three reset codes "343434", "565656", and "787878" to the device administrator.
(5) Then, the device administrator inputs the three reset codes into any one image forming apparatus 10 of the three image forming apparatuses 10A to 10C on which a password reset is to be performed. For example, in FIG. 4, the device administrator inputs the three reset codes into image forming apparatus 10A. An example of an operation screen when inputting the three reset codes as above is illustrated in FIG. 6. FIG. 6 illustrates the situation in which the device administrator enters the reset codes for the three devices via the operation panel of the image forming apparatus 10A. As above, the controller 35 receives input of the reset codes for the three devices, corresponding to the multiple image forming devices 10A to 10C, for resetting the previously set password. The entered reset codes for the three devices are managed and stored in a table as illustrated in FIG. 7 in the image forming apparatus 10A. Referring to FIG. 7, it is illustrated that the reset codes for the three devices are stored along with information on the input route. Here, the input route being "LUI (Local User Interface)" means that the reset codes were input either via the device's own operation panel or through a terminal device connected to the device itself.
(6) Next, the controller 35 encrypts the input reset codes for the three devices using a public key of a public key encryption system.
(7) Then, the controller 35 transmits the encrypted reset codes for the three devices along with the device's own identification information to the management server 20, which is an external device, requesting permission for password reset. In the following description, the case in which the serial number is used as the device's own identification information will be described. That is, the controller 35 transmits the encrypted reset codes for the three devices, i.e., "343434", "565656", "787878", along with the device's own serial number "10012345" to the management server 20.
(8) Upon receiving the password reset permission request from the image forming apparatus 10A, the management server 20 decrypts the encrypted reset codes for the three devices, "343434", "565656", and "787878", using a private key. Then, referring to the reset code management table illustrated in FIG. 5, the management server 20 determines whether to permit password reset. Specifically, if it is confirmed that any of the received reset codes match the received serial number, the management server 20 permits the password reset. Here, since the serial number "10012345" corresponds to the reset code "343434", the management server 20 determines that permission for password reset should be granted.
(9) Then, the management server 20 responds to the image forming apparatus 10A, which transmitted the password reset permission request, indicating that password reset is permitted.
(10) When the management server 20 responds to the image forming apparatus 10A granting permission for password reset in this manner, the controller 35 requests the device administrator to enter information to be set as a new password. An example of an operation screen when requesting the device administrator to enter information to be set as a new password is illustrated in FIG. 8. Referring to FIG. 8, the situation in which the device administrator enters the new password "258369" is illustrated. When the machine administrator enters information to be set as a new password in this way, the controller 35 sets the information entered as the new password.

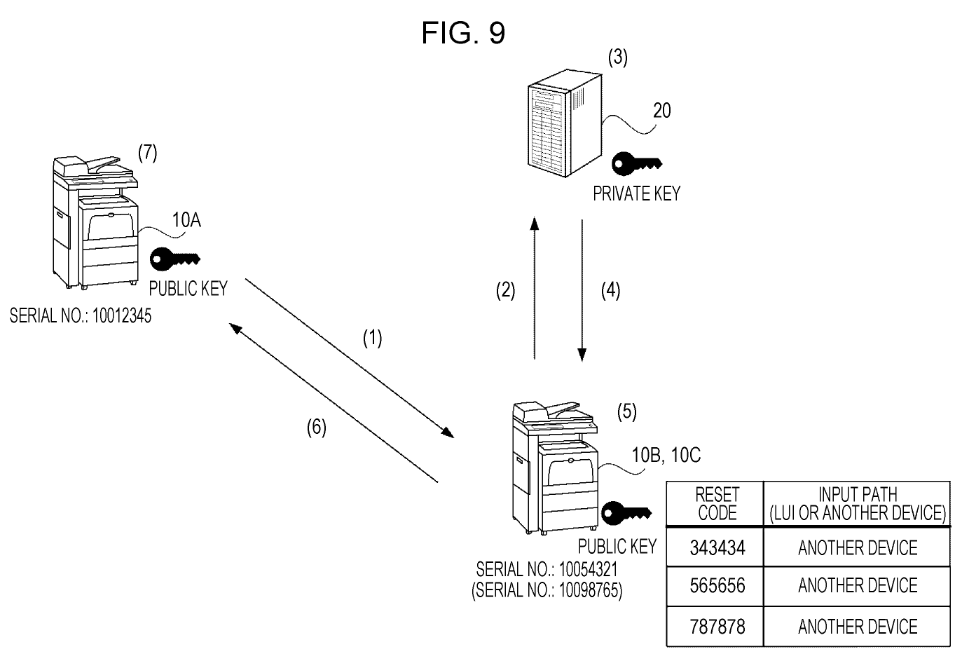

The flow of processing when a password reset is performed on the image forming apparatuses 10B and 10C after the password has been reset on the image forming apparatus 10A is illustrated in FIG. 9. In FIG. 9, a password reset on the second and subsequent devices, namely the image forming apparatuses 10B and 10C, is executed according to steps (1) through (6) described below.
(1) The controller 35 of the image forming apparatus 10A, whose password has been reset, transmits the entered reset codes for the three devices to the other image forming apparatuses 10B and 10C, which have been pre-registered as belonging to the same group. Here, it is assumed that the image forming apparatuses 10A to 10C have been mutually registered in advance as belonging to the same group.
(2) Upon receiving the reset codes for the three devices from the image forming apparatus 10A, the controllers 35 of the image forming apparatuses 10B and 10C encrypt the received reset codes using a public key of a public key encryption system, and transmit them respectively along with their own serial numbers "10054321" and "10098765" to the management server 20 to request permission for password reset. Note that, in the image forming apparatuses 10B and 10C, the received reset codes for the three devices are stored with the input path recorded as "another device".
(3) Upon receiving the password reset permission request from the image forming apparatuses 10B and 10C, the management server 20 decrypts the encrypted reset codes for the three devices, "343434", "565656", "787878", using a private key. Then, referring to the reset code management table illustrated in FIG. 5, the management server 20 determines whether to permit password reset. Specifically, if it is confirmed that any of the received reset codes match the received serial numbers, the management server 20 permits password reset. Here, since the serial number "10054321" corresponds to the reset code "565656", and the serial number "10098765" corresponds to the reset code "787878", the management server 20 determines that permission for password reset should be granted.
(4) Then, the management server 20 responds to the image forming apparatuses 10B and 10C, which transmitted the password reset permission request, indicating that password reset is permitted.
(5) When the image forming apparatuses 10B and 10C receive the response from the management server 20 indicating that password reset is permitted, the controllers 35 of the image forming apparatuses 10B and 10C automatically sets a new password, as the input path of the reset codes is marked as "another device".

That is, when multiple reset codes are those locally entered on the device, the controller 35 requests the user to enter information to be set as a new password if a response is received from the management server 20 indicating permission for password reset; and, if the reset codes are those received from another image forming apparatus 10, the controller 35 sets a new password without requesting the user to enter information to be set as the new password.

Specifically, if the device administrator's email address has not been set, the controller 35 may set the device's own serial number, which is the device's own identification information, as the new password. Alternatively, if the device administrator's email address has been set, the controller 35 may set information generated locally by the device as the new password, and notify the device administrator of the new password via the device administrator's email address, which is set in advance as a contact address.

Furthermore, in some cases, the device administrator may want to set the same password across all the three devices, the image forming apparatuses 10A to 10C. In such cases, the controller 35 of the image forming apparatus 10A, whose password has been initially reset, transmits the information set as the new password along with the input reset codes for the three devices to the image forming apparatuses 10B and 10C, which are pre-registered as belonging to the same group. Then, when setting a new password without requesting the user to enter information to be set as the new password, the controllers 35 of the image forming apparatuses 10B and 10C use the information transmitted from the image forming apparatus 10A as the new password. With this processing performed, the same password is set on the image forming apparatuses 10A to 10C.

(6) After the automatic password reset has been performed as above in the image forming apparatuses 10B and 10C, their controllers 35 transmit the result of the password reset to the image forming apparatus 10A.

(7) Finally, the controller 35 of the image forming apparatus 10A receives, as result information, the processing result of the password reset from the image forming apparatuses 10B and 10C, to which the reset codes for the three devices have been transmitted, and displays it on the operation panel, for example.

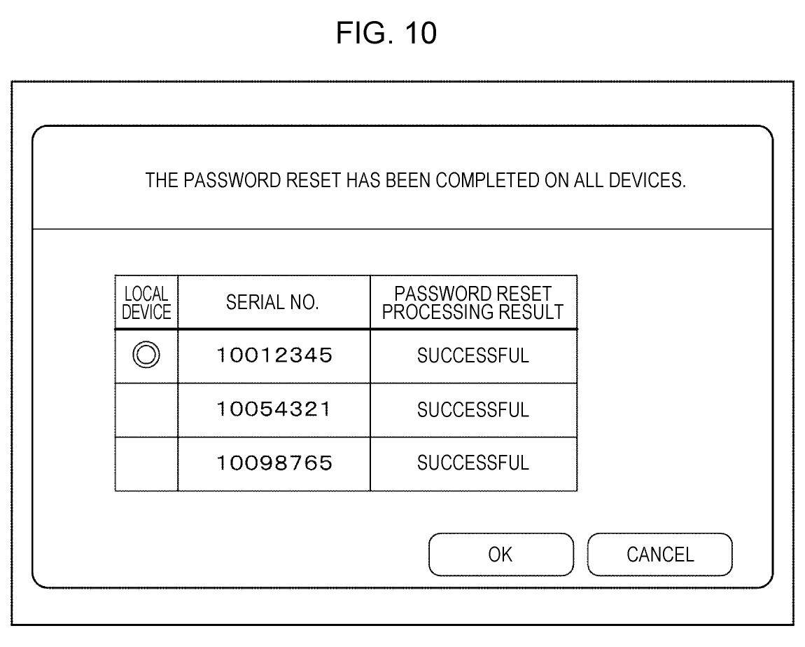

An example of a display screen of the processing result of the password reset displayed on the operation panel of the image forming apparatus 10A in this manner is illustrated in FIG. 10.

Referring to FIG. 10, it can be seen that the serial numbers of the three image forming apparatuses 10A to 10C, on which password reset has been simultaneously performed, and the processing result of the password reset on the respective image forming apparatuses 10 are displayed. In FIG. 10, it is indicated that the password reset was successfully completed on all three image forming apparatuses 10A to 10C. Since FIG. 10 illustrates the operation panel of the image forming apparatus 10A, it also indicates that the image forming apparatus 10 with the serial number "10012345" is the local device.

In the exemplary embodiment above, the term "processor" refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment above, the operation of the processor may be performed not only by a single processor but also by plural processors in collaboration which are located physically apart from each other but may work cooperatively. The order of operations of the processor is not limited to one described in the exemplary embodiment above, and may be changed.

The term "system" in the present exemplary embodiment includes both a configuration consisting of multiple devices and one consisting of a single device.

The present disclosure can also be applied to programs and program products.

### Modifications

Although it has been described in the above-described exemplary embodiment using the case where the present disclosure is applied to an image forming apparatus, the present disclosure is not limited thereto. The present disclosure can be similarly applied to any information processing apparatus that has a function of resetting a password using a reset code.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

### (((1)))

An information processing apparatus including:
a processor configured to:
receive input of multiple reset codes, corresponding to multiple information processing apparatuses, for resetting a previously set password;
transmit the input reset codes and the information processing apparatus's own identification information to an external device;
if there is a response from the external device indicating permission for password reset, set information entered as a new password; and
transmit the input reset codes to other information processing apparatuses that have been pre-registered as belonging to a same group.

### (((2)))

The information processing apparatus according to (((1))), wherein the processor is configured to transmit the information set as the new password, along with the input reset codes, to the other information processing apparatuses pre-registered as belonging to the same group.

### (((3)))

The information processing apparatus according to (((1))) or (((2))), wherein the processor is configured to obtain and display, as result information, a processing result of password reset from the other information processing apparatuses, to which the reset codes have been transmitted.

### (((4)))

The information processing apparatus according to (((1))), wherein the processor is configured to:
in a case where the reset codes are those locally entered on the information processing apparatus, if a response is received from the external device indicating permission for password reset, request a user to enter information to be set as a new password; and
in a case where the reset codes are those received from another information processing apparatus, if a response is received from the external device indicating permission for password reset, set a new password without requesting a user to enter information to be set as the new password.

### (((5)))

The information processing apparatus according to (((4))), wherein the processor is configured to, when setting a new password without requesting the user to enter information to be set as the new password, set information transmitted from another information processing apparatus as the new password.

### (((6)))

The information processing apparatus according to (((4))), wherein the processor is configured to, when setting a new password without requesting the user to enter information to be set as the new password, set the information processing apparatus's own identification information as the new password.

### (((7)))

The information processing apparatus according to (((4))), wherein the processor is configured to:

when setting a new password without requesting the user to enter information to be set as the new password, set information generated locally by the information processing apparatus as the new password; and

notify a preset destination of the set new password.

### (((8)))

A program causing a computer of an information processing apparatus to execute a process including:

receiving input of multiple reset codes, corresponding to multiple information processing apparatuses, for resetting a previously set password;

transmitting the input reset codes and the information processing apparatus's own identification information to an external device;

if there is a response from the external device indicating permission for password reset, setting information entered as a new password; and

transmitting the input reset codes to other information processing apparatuses that have been pre-registered as belonging to a same group.

What is claimed is:

1. An information processing apparatus comprising:
a processor configured to:
receive input of a plurality of reset codes, corresponding to a plurality of information processing apparatuses, for resetting a previously set password;
transmit the input reset codes and the information processing apparatus's own identification information to an external device;
if there is a response from the external device indicating permission for password reset, set information entered as a new password; and
transmit the input reset codes to other information processing apparatuses that have been pre-registered as belonging to a same group.

2. The information processing apparatus according to claim 1, wherein the processor is configured to transmit the information set as the new password, along with the input reset codes, to the other information processing apparatuses pre-registered as belonging to the same group.

3. The information processing apparatus according to claim 1, wherein the processor is configured to obtain and display, as result information, a processing result of password reset from the other information processing apparatuses, to which the reset codes have been transmitted.

4. The information processing apparatus according to claim 1, wherein the processor is configured to:
in a case where the reset codes are those locally entered on the information processing apparatus, if a response is received from the external device indicating permission for password reset, request a user to enter information to be set as a new password; and
in a case where the reset codes are those received from another information processing apparatus, if a response is received from the external device indicating permission for password reset, set a new password without requesting a user to enter information to be set as the new password.

5. The information processing apparatus according to claim 4, wherein the processor is configured to, when setting a new password without requesting the user to enter information to be set as the new password, set information transmitted from another information processing apparatus as the new password.

6. The information processing apparatus according to claim 4, wherein the processor is configured to, when setting a new password without requesting the user to enter information to be set as the new password, set the information processing apparatus's own identification information as the new password.

7. The information processing apparatus according to claim 4, wherein the processor is configured to:
when setting a new password without requesting the user to enter information to be set as the new password, set information generated locally by the information processing apparatus as the new password; and
notify a preset destination of the set new password.

8. A non-transitory computer readable medium storing a program causing a computer of an information processing apparatus to execute a process comprising:
receiving input of a plurality of reset codes, corresponding to a plurality of information processing apparatuses, for resetting a previously set password;
transmitting the input reset codes and the information processing apparatus's own identification information to an external device;
if there is a response from the external device indicating permission for password reset, setting information entered as a new password; and
transmitting the input reset codes to other information processing apparatuses that have been pre-registered as belonging to a same group.

9. An information processing method performed by an information processing apparatus, the information processing method comprising:
receiving input of a plurality of reset codes, corresponding to a plurality of information processing apparatuses, for resetting a previously set password;
transmitting the input reset codes and the information processing apparatus's own identification information to an external device;
if there is a response from the external device indicating permission for password reset, setting information entered as a new password; and
transmitting the input reset codes to other information processing apparatuses that have been pre-registered as belonging to a same group.
